(19) United States
(12) Patent Application Publication
(10) Pub. No.: US 2024/0026606 A1
(43) Pub. Date: Jan. 25, 2024

(54) METHOD FOR SEPARATING CELLULOSIC PARTICULATES OUT OF FIBER SUSPENSIONS AND/OR FILTRATES

(71) Applicant: Papierholz Austria GmbH, St. Gertraud (AT)

(72) Inventors: Johannes LEITNER, Leonding (AT); Lukas ZANGL-JAGIELLO, Villach (AT); Wolfgang Johann FISCHER, Graz (AT); Samir KOPACIC, Graz (AT); Daniel MANDLEZ, Graz (AT); Rene ECKHART, Graz (AT); Wolfgang BAUER, Graz (AT)

(73) Assignee: Papierholz Austria GmbH, St. Gertraud (AT)

(21) Appl. No.: 18/257,366

(22) PCT Filed: Feb. 17, 2022
(86) PCT No.: PCT/EP2021/085695

§ 371 Date: Jun. 14, 2023

(51) Int. Cl. D21D 5/00; D21H 23/24; D21H 23/10

(52) U.S. Cl. CPC D21D 5/00; D21H 23/24; D21H 23/10

(57) ABSTRACT

The invention relates to a method for separating particulates out of filtrates of a paper, cardboard, paperboard or pulp production plant and for reapplying the separated particulates to a surface of paper, cardboard or paperboard, comprising at least the following steps: a) separating the particulates out of the filtrates at a size of less than 1200 pm, b) coagulating the separated particulates of same, c) as applicable, mixing the separated particulates with further particulates from a paper, paperboard or pulp production, and/or microfibrillated cellulose (MFC), d) forming an aqueous suspension from the particulates, e) as applicable, adding to the suspension further additives for the surface treatment of paper or paperboard, selected from native and oxidatively degraded starch or calcium carbonate, f) homogenously applying the formed suspension to a paper or paperboard surface in a quantity between 0.5 and 30 g/m², in particular 4 and 15 g/m², and g) drying the paper or paperboard.

### BACKGROUND OF THE INVENTION

### Field of the Invention

The present invention relates to a method for separating cellulosic particulates out of fibre suspensions and/or filtrates of a paper or pulp plant and for simultaneously reapplying the separated cellulosic particulates to a surface of paper, cardboard or paperboard, also to paper, cardboard or paperboard prepared with this method.

### Prior Art

As is generally known, in order to manufacture paper, cardboard, and paperboard, lignocellulosic raw material is used, in particular wood that has been pulped either mechanically or chemically as part of the wood or pulp production process, in particular with the addition of various chemicals. The pulped and refined fibrous material is then mixed with additional substances, such as fillers, for example calcium carbonate, starch, chemical additives and like, and subsequently passed through a mesh and dewatered, after which, when a sheet or a pulp layer has been produced, sizing agents, wet strength agents or other additives are also added as required. Given a production process of this kind for paper, cardboard, or even paperboard as well as wood and pulp, modern industrial producers are concerned to keep the quantity of the process waters needed, the waste materials, and that of the unused boiling chemicals or additives as low as possible through closed production cycles, in order to be able to achieve good mass and energy balances. When a fibrous material or fibre suspension is refined and/or dewatered, particularly when it is filtered in conventional filtration plants, the resulting filtrate contains not only many chemicals and/or additives but also significant quantities of particulates which are suspended in said filtrates and are normally retained in the process through suitable method arrangement using equipment such as disc filters, wash presses, flotation units and the like. At another point in the paper, cardboard and paperboard production process the fibre suspensions are subsequently dewatered intensively when the fibre suspension is passed through the mesh, in order to obtain a dry paper or paperboard web afterwards with presses and drying unit. Particulates and any additives used are washed out of the fibre network together with the filtrates. These particulates are removed when the filtrate is filtered by means of curved screen, disc filter, DAF (Dissolved Air Flotation) or similar units to enable the filtrate to be reused. More recently, it was discovered that the application of micro- or nanofibrillated cellulose (MFC or NFC) in an application or the application on a paper, cardboard or paperboard can alter the properties thereof, thereby making it possible to obtain improved mechanical properties, change the barrier properties (e.g. air permeability, oxygen or water vapour transmission or grease permeability) of the paper, cardboard or paperboard, to improve the optical properties (e.g., gloss) and well as its/their water absorption. For the purposes of this document, the term microfibrillated or nanofibrillated cellulose is understood to represent a cellulose which is produced by high pressure homogenisation or fine grinding of conventional pulp with or without the use of chemicals or enzymes or the like, or grinding together with other grinding media, such as for example ground calcium carbonate, clay (kaolin) or other minerals. The disadvantage of a commercially manufactured micro- or nanofibrillated cellulose of such kind consists in that it cannot be produced without substantial energy consumption. Furthermore, transport of MFC or NFC is not financially appealing because of the mostly low solid content in an aqueous suspension.

The application of micro- or nanofibrillated cellulose or microfibrillated cellulose fragments is described for example in the document Beneventi et al. (2014); Industrial & Engineering Chemistry Research 53(27):10982-10989, according to which such microfibrillated cellulose fragments (MFC fragments) are sprayed onto a fibrous web in order to manufacture composite materials with better or more favourable surface and barrier properties.

A method for manufacturing paper in which two fractions of fibres, one long fibre fraction and one fraction with short fibres or fibres containing particulates are mixed together, and paper is made from this, was published in JP 2016130387.

The article Pulp Fines Characterisation, Sheet Formation and Comparison to Microfibrillated Cellulose; Polymers (Basel); 2017 Aug. 17; 9(8):366 by Fischer W J, Mayr M, Spirk S, Reishofer D, Jagiello L A, Schmiedt R, Colson J, Zankel A, Bauer W. describes the separation of particulates from a wide range of pulps and the subsequent sheet formation from these separated particulates.

In the course of experiments, it was found that the fibrous or cellulosic particulates contained in fibre suspensions and various filtrates from the paper, cardboard, paperboard and pulp production process can be used in a similar way to micro- or nanofibrillated celluloses to modify the surface and barrier properties and the mechanical properties of paper, cardboard and paperboard.

### DESCRIPTION OF THE INVENTION

The objective of the present invention is therefore to provide a method with which it is financially possible to deliver fibre suspensions and/or filtrates containing cellulosic particulates originating from paper production or pulp production for further processing and/or for reacting with further additives in such manner that the cellulosic particulates contained therein, can be applied to paper, cardboard or paperboard, optionally together with further components of the filtrates, in order to improve the surface, barrio and mechanical properties thereof.

In order to solve this object, the method according to the invention is essentially arranged in such manner that at least the following steps are carried out.
a) Separation of the cellulosic particulates out of the filtrates with a size less than 1200 μm, in particular less than 900 μm, preferably less than 600 μm, more preferably less than 400 μm, particularly preferably less than 200 μm (measured according to ISO 16065-1) and of further contained additives as applicable,
b) as applicable coagulating the separated cellulosic particulates of same,
c) as applicable mixing the separated cellulosic particulates with further particulates from paper, cardboard, paperboard or pulp production, and/or micro- or nanofibrillated cellulose (MFC or NFC),
d) as applicable forming an aqueous suspension from the particulates, or as applicable from the mixture of particulates originating from paper, cardboard, or paperboard production with additives,
e) as applicable adding to the suspension of additives used in paper, cardboard, paperboard or pulp production, in particular native, derivatized or oxidatively treated starch, sizing agents, wet strength agents or other chemical additives or from minerals such as for example calcium carbonate or kaolin,
f) homogeneous application of the suspension formed to the surface of a paper, cardboard or paperboard web in a quantity between 4 and 15 g abs. dry/m² (abs. dry=absolutely dry) of the solids present in the suspension, wherein the particulate content in the suspension constitutes up to 100% of the dry mass contained in the suspension, preferably less than 90.0% of the dry mass contained in the suspension, and
g) drying the paper, cardboard or paperboard and as applicable simultaneous or subsequent pressing, satinising, coating with additives in a film- or pond-style size press or a spraying process or other coating units used in paper, cardboard and paperboard production,
h) as applicable repeating steps f) and g).

With a method arrangement of such kind, not only does it become possible to separate cellulosic particulates out of an enormous variety of filtrates and/or fibre suspensions generated in paper, cardboard, paperboard or pulp production, but these separated cellulosic particulates and the separated fibrous components in general can also be returned to the very same production process, or used in the production of a different paper, cardboard or paperboard quality from the one from whose filtrates they were removed but at a later time, directly and without having to be transported to a different usage location, geographically removed from the site where the cellulosic particulates were obtained, in particular to another paper, cardboard, paperboard or pulp factory. Surprisingly, it was found that no impairment of any kind of the properties is observed, either in the subsequent production process of paper and/or cardboard and/or paperboard or in the finished product produced, due to the separation of particulates out of the filtrates from paper, cardboard, paperboard or pulp production, in particular no impairment of the properties of any kind can be found in the paper, cardboard- or paperboard body, even though the separation of the cellulosic particulates resulted in the removal of a not inconsiderable content of components of the fibre suspensions and filtrates were removed therefrom. Surprisingly, it was even found that with a method arrangement according to the invention the effectiveness of additives remaining in the production process can actually be increased by the removal of the particulates from the fibre suspension, and the dewatering of the fibre suspension can be improved.

### SUMMARY OF THE INVENTION

A return of cellulosic particulates from filtrates from paper, cardboard, paperboard and pulp production to the production process of paper, cardboard, paperboard or pulp, e.g., adding the particulates before grinding or to the mixing tank after grinding, or at other points in the paper production process before the headbox, are known in the state of the art. However, it was demonstrated that the effectiveness of the essential additives used is adversely affected by this new addition of the cellulosic particulates into the production process, and that the presence of particulates in the fibre suspension has a significantly negative effect on the dewatering of same. Thus for example, the freeness (according to ISO 5267-1:2004) could be improved from 20° SR to 15° SR by removing a portion of the particulates, as is done in the present invention, wherein the tensile strength index of the paper samples with partial removal of the cellulosic particulates increased to 103-106 N/mg (based on ISO 1924-3:2005 laboratory sheets according to ISO 5269-2:2004, grammage according to ISO 536:2012) as opposed to a comparison without reduction of the particulates, in which it had a value of 98-101 Nm/g (based on ISO 1924-3:2005 laboratory sheets according to ISO 5269-2:2004, grammage according to ISO 536:2012). Furthermore, the return of the particulates from the filtrates practised in the prior art gives rise to a greater need for retention agents as part of the chemical paper additives, which, depending on the paper, cardboard and paperboard qualities produced, can be added to the fibre suspension in the constant section of a paper, cardboard and paperboard machine (until immediately before the headbox). Standard two-component retention agent systems consist of long-chain cationic and short-chain anionic polymers, or said anionic polymers may optionally also be replaced by anionic microparticles and are mostly used to bind fibres and mainly cellulosic particulates and inorganic fillers in the moist, circulating paper at the straining part of a papermaking machine. In this context, firstly the specific chemical costs for retention agent systems of such kind are not inconsiderable, and secondly it is only seldom possible to achieve a target value of over 90% total retention when using them. The method arrangement described in the method according to the invention makes it possible to dispense with the unfavourable return of the cellulosic particulates described above. By the separation of the particulates and fillers out of the fibre suspensions and/or filtrates and their application to a paper web, such as at the straining section of papermaking machine, for example, almost 100% retention may be achieved, and accordingly the dosage of retention agents may also be reduced substantially, which represents a significant simplification of the method arrangement.

Through the separation and optionally the mixing of the separated cellulosic particulates with further particulates from other process steps of the production process, or also with attendant substances such as additives, chemicals or minerals, from paper-, cardboard-, paperboard- or pulpmaking, it is possible to prepare a surface coating material that originates directly from the method, and can in turn be applied to the surface of the paper, cardboard or paperboard in the same method after or during sheet formation. Depending on the type of the additives contained in the various filtrates originating from paper, cardboard or paperboard production, and/or by the selective addition of additives, chemicals or minerals or the like as applicable, it is possible to carry out a selective surface treatment of the paper, cardboard or paperboard with results yielding an order of improvement that was entirely unexpected for a person skilled in the art.

Thus for example it has proven possible to reduce the air permeability of the paper, cardboard, or paperboard (Gurley value according to ISO 5636-5:2003) through the application of particulates separated out of the filtrates to such an extent that the paper or paperboard is almost completely impermeable to air.

Particulates as well as attendant substances in the filtrates from paper, cardboard, paperboard and pulp production have differing properties. In practice, these will lead to different results in the finished product, that is to say the paper, cardboard, or paperboard, but these differences are not solely attributable to the following division into three groups of particulates; rather, they are also characterized by the nature of the attendant substances which are separated together with the particulates, and are mostly suspended or dissolved in the aqueous suspension. In the context of the present invention, particulates or also pulp fibres understood to include the following materials:
Primary particulate: A particulate that consists primarily of particulate, lignocellulosic substances and is preferably separated out from an unground pulp suspension.
Secondary particulate: A particulate that is produced primarily by a mechanical fibre treatment such as grinding in pulp and paper, cardboard, paperboard production;
Other types of particulates, such as for example chemicals, additives and minerals, which originate from the filtrates from paper, cardboard, paperboard and pulp production.

In this context, the term attendant substances is understood to refer to additives, chemicals or minerals which are separated at the same time in a filtration process during the paper, cardboard, paperboard and pulp production, on the one hand because of their size or solubility in the respective filtrate, and on the other hand due to the fact that they are bound either chemically or physically to the particulates.

The terms pulp and fibrous material are here understood to mean both pulp and/or fibrous material from the chemical wood pulping process and mechanical wood pulp from the various mechanical wood pulping methods and variations (such as thermochemical mechanical wood pulp) of these commonly practised processes in the paper and pulp industry.

In this context, the following are considered to be additives, chemicals and minerals used in paper, cardboard, paperboard or pulp production:
calcium carbonate,
talcum,
clay (kaolin) or
titanium dioxide or other minerals
   and optionally additives and chemicals such as
sizing agents, e.g.
   alkylated ketene dimers (AKD),
   succinic acid anhydrides (ASA),
   anionically and cationically modified resinic and fatty acids
native and modified starches such as
   derivatized cationic, anionic and amphoteric starches,
   oxidatively treated starches
   enzymatically treated starches, or
   starches degraded by acid catalysis
retention agents
wet strength agents (epichlorohydrin, urea formaldehyde or similar)
surfactants (gen. tensides) (anionic, cationic, non-ionic tensides)
organic (cationic and anionic polymers) and inorganic (e.g., aluminium sulfate, polyaluminium chloride) fixing agents or all other chemical additives used in paper, cardboard or paperboard production
grease-repellent chemicals:
   fluorine-based formulations
   perfluoroalkyl acids (PFAAs) such as perfluorocarboxylic acids (PFCAs) or perfluorosulfonic acids (PFSAs)
   fluorine-free formulations, based for example on starch derivatives, modified polymers, etc.

Filtrates from paper, cardboard, paperboard and pulp production are understood to refer to the following process streams, among others:
Washing filtrates such as those from brown stock washing, bleach etc:
Clear filtrate
Turbid filtrate
Machine white waters

According to a further development of the invention, the method is arranged such that one or more of the fibre suspensions and/or filtrates is/are introduced into a papermaking machine, cardboard or paperboard machine or pulp production plant after a screening unit, such as a pressure screening system for example, a curved screen or a belt washer, which are used in the separation step for separating particulates and as applicable other additives contained. By introducing one or more of the fibre suspensions and/or filtrates into a papermaking machine or a pulp production plant after a screening unit that is used in the separating section to separate particulates and as applicable further additives contained, it is possible on the one hand to avoid the known negative or disadvantageous effects of the particulates, such as the effects on dewatering or the quantity of retention agents required, and on the other hand at the same time to obtain a paper, cardboard or paperboard product whose surface properties are considerably improved compared with conventionally treated surfaces of paper, cardboard and paperboard.

By arranging the method in a manner corresponding to a further development of the invention such that the separation of the particulates out of the fibre suspensions and/or filtrates is carried out in a single- or multistage separation and/or filtration process, in particular with a screening unit or a disc filter or a flotation process, such as a DAF (Dissolved Air Flotation) process, it may be ensured that all particulates of a certain size or thickness and optionally further additives accumulating on the surface thereof are extracted from the paper production process and are subsequently available for application to the paper surface. In this context, processes such as a separation process with the aid of screening units such as pressure screening systems disc filters or flotation processes such as DAF, in which the particulates are successfully induced to float on the surface of the filtrate, have proven particularly advantageous. With a separation process of such kind, not only is a very large component of the cellulosic particulates contained in the filtrates and/or fibre suspensions recovered, but additionally it is also assured that few if any additional aids have be implemented to guarantee a substantially total and quantitative separation of the particulates out of the filtrates.

To ensure that when the particulates recovered from the fibre suspensions and/or filtrates, and as applicable further additives are applied to a paper, cardboard or paperboard surface they do not moisten them unnecessarily and thereby not only entail an increase in method costs but also necessitate drastic modification of the method arrangement, the method according to the invention is essentially arranged in such manner that a coagulation of a particulate suspension is performed until a total solid content comprising cellulosic particulates and as applicable additives originating from paper, cardboard or paperboard production between 1 and 30% by weight, in particular 3 to 10% by weight is achieved. A coagulation until a content of particulates and as applicable additives originating from paper, cardboard or paperboard production between 1 and 30% by weight, in particular 3 to 10% by weight relative to the dry mass is obtained results in a suspension having a relatively high content of cellulosic particulate being applied to the surface of the paper, cardboard or paperboard, to enable the product to be provided directly with improved surface properties, in particular a considerably reduced air permeability.

To ensure that the surface finishing with the method according to the invention can be carried out in a single step and it is not necessary to perform two distinctly separate steps of applying particulates first and afterwards applying excipients and additives, the method according to the invention has been developed further essentially to the effect that at least one additive selected from the group consisting of calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents as well as retention agents or the like are added to the suspension formed from the cellulosic particulates as further additives for the surface treatment of paper, cardboard or paperboard. By the addition of further additives to the suspension formed from the particulates, the person skilled in the art in the field of papermaking can already prepare a suspension in advance, with which he can achieve the desired surface properties of a finished paper, cardboard or finished paperboard that are most favourable for him. Needless to say, an application of the cellulosic particulates and the further additive may also be carried out multiple times at various points in the production of paper, paperboard or cardboard, such as for example in the straining section and later on the dry paper.

Desired surface properties are for example barrier properties, such as a defined air permeability and water vapour permeability, surface properties such as rendering a surface water repellent or reducing roughness, as well as mechanical properties like a change of the tensile energy absorption (TEA), an increase of the flexural stiffness, but also optical properties such as the brightness or gloss of the paper can be improved and/or increased in this way.

In this context, it is important to select the exact ratio between the cellulosic particulates and further additives such that the desired surface properties of the finished paper, cardboard or the finished paperboard can be obtained. According to a further development of the invention, the ratio is essentially selected in such manner that a ratio of particulate to further additives between 1:100 and 100:1, preferably between 1:80 and 80:1, more preferably between 1:20 and 20:1, most preferably between 1:15 and 15:1, such as for example 3:1 or 1:3 is selected. Even though here a large and in particular wide range is covered by the present invention, a person skilled in the art in this technical field will understand that, depending on the desired surface properties of the finished paper, cardboards or the finished paperboard an enormous variety of different application quantities of the individual components must be accessible, with the result that, if for example an air-impermeable paper is to be produced, the particulate content must be higher, whereas when a hydrophobic character of the paper, cardboard or paperboard is to be increased, a larger quantity of excipients is required. An exemplary composition of particulates and additives consists for example of 99.9% particulates and 0.1% additives, such as fillers and pigments, whereby a coating consisting almost exclusively of particulates may be prepared. Similarly, a composition of just 10% particulates and 90% additives such as pigments, wet strength agents or fillers might be prepared, in which case for example a more strongly pigmented surface can be obtained.

Particularly good properties may be obtained if the method is arranged in such manner that the particulates are applied in the form of particulates impregnated with further additives originating from paper, cardboard or paperboard production, such as calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents, or in the form of adducts of the additives on the surface of the particulates. When the method is arranged in this manner, it is possible in particular to achieve a totally uniform distribution of both particulates and further additives originating from paper, cardboard and paperboard production on the surface of paper or paperboard, and in particular a homogeneous end product may be obtained. Not only do homogeneous end products of such kind manifest improved surface properties, it can in particular be ensured that since the particulate particles are impregnated with the further additives such as calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents, or exist as adducts with said substances, at least both products can always be applied in a single selective quantity ratio to each other, and consequently spread particularly evenly over the surface.

In order to subsequently apply the particulates separated out from the immensely wide variety of filtrates and/or fibre suspensions from paper, cardboard or paperboard production to the surface of paper, cardboard or paperboard, it has proven advantageous to adjust the Ph of the suspension, wherein different Ph values of the suspension can be set depending on the desired surface properties. In this context, according to the invention Ph values of Ph 2 and Ph 11, preferably Ph 3.5 and Ph 9.5, in particular 4 to 9 have proven preferable for a suspension to be applied to paper, cardboard or paperboard surfaces.

According to the invention, surface coating processes such as a surface coating of a paper web, cardboard or paperboard web having a dry content between 2% and 100%, preferably 5% to 95%, particularly preferably 10% to 50%, such as for example in a film press or pond-style size press or a spraying process have proven to be particularly good for the application of particulates recovered from fibre suspensions and/or filtrates from paper, cardboard or paperboard production to a moist paper surface. In a coating process of such kind, the moist paper web already has a structure and the most important parameters that can be set by the papermaking machine have already been fixed, such as the grammage of a paper, but the surface properties of the paper may be adapted to the final requirements particularly efficiently at this time.

By arranging the method according to the invention in such a way that after the surface coating process a surface finishing process is carried out, such as satinising, pressing, drying on a polished, machine-smoothed Yankee cylinder, in a coating system such as a film- or pond-style size press, rolling or calendaring, it is possible to enhance the surface improvements obtained by the surface coating still further using the particulates separated out of the fibre suspensions and/or filtrates from paper, cardboard and paperboard production, for example by obtaining still greater smoothness, air impermeability and the like with the surface finishing process.

The invention further relates to a paper, a cardboard or a paperboard that are manufactured in accordance with a method according to the invention. A paper, cardboard or paperboard of such kind is essentially characterized in that the paper, cardboard or paperboard has a surface coating containing between at least 0.5 g abs. dry/m² and 30 g abs. dry/m², in particular 4 g abs. dry/m² and 15 g abs. dry/m² particulates, and further additives as applicable. By producing a paper, cardboard or paperboard having a surface coating that contains at least 0.5 g abs. dry/m² and not more than 30 g abs. dry/m² particulates as well as optionally further additives in the coating, it is possible to provide a paper, a cardboard and a paperboard that exhibit significantly improved surface properties compared with conventionally manufactured products. Thus for example, an almost completely air-impermeable paperboard or air-impermeable paper or air-impermeable cardboard may be provided, a paper, cardboard with improved gloss, an improved moisture resistance and/or greater smoothness may be obtained, wherein all of these properties are always considered in comparison with a paper, paperboard or cardboard that was produced from a fibre suspension in which the particulates were not extracted in the course of the process, and were not re-applied as surface coating material in the production process as in the method according to the present invention.

According to a further development of the invention, a paper of such kind is constructed in such a way that the surface coating consists of a mixture of particulates, in particular a mixture of particulates and additives contained in the filtrates from paper, cardboard, paperboard or pulp production. A paper of such kind differs from conventionally manufactured papers essentially in that almost exclusively additives and particulates originating from the method are used for the surface finishing thereof, and it is consequently possible with a paper of such kind to realise not only significant cost savings but in particular savings in terms of raw materials.

In order to be able to adapt the surface properties of such a paper, cardboard, or paperboard exactly to the subsequent requirements, the paper, cardboard or paperboard is developed further to such effect that besides particulates, the mixture of particulates and the additives originating from filtrates from paper, cardboard, paperboard or pulp production, such as calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents, the surface coating contains further additives that were deposited before the coating, such as tensides, pigments or fillers. Due to the addition of further additives added before the coating, apart from the positive effects provided by the particulates and the additives originating from production, it is possible in particular to influence the surface properties of the paper in selective manner and thus provide corresponding paper qualities and/or paperboard qualities that are thus adapted exactly to the requirements of the end user.

The quantities of the further additives in the surface coating are in the range from 0.5% by weight to 99% by weight of the dry mass of the coating suspension, thereby making it possible to provide papers, cardboards and paperboards that are not only tailored precisely to the needs of the end user but at the same time also produced inexpensively.

### DESCRIPTION OF THE DRAWINGS

In the following text, the invention will be explained in greater detail with reference to drawings and exemplary embodiments thereof. In the drawings

FIG. 1 is a schematic representation of a flowchart of an integrated pulp, paper, cardboard or paperboard factory, showing schematically the capability of separating particulates and the final application of same.

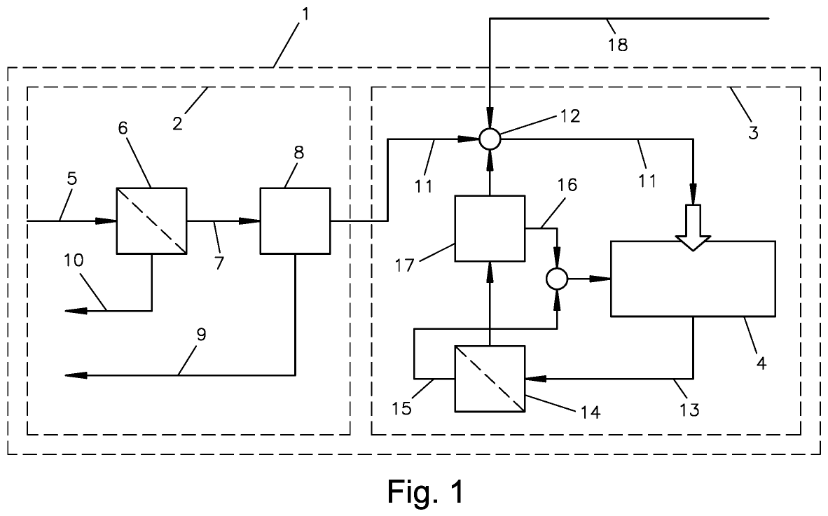

### DETAILED DESCRIPTION OF THE INVENTION

In this representation, an integrated pulp, paper, cardboard or paperboard production site is indicated by the broken peripheral line 1, the integrated paper and pulp production facility being divided into two separate plants, like a pulp production plant that might also be a paper, cardboard or paperboard production facility, which is represented by another broken peripheral line 2, and will be referred to as a pulp production plant 2, and a paper, cardboard- or paperboard production facility, which is divided by a further broken peripheral line 3.

In the pulp production plant 2, in this case an unbleached fibre feedstock material or a fibrous material or also a filtrate is introduced at 5 into a separation apparatus 6, which may be for example a filtration system, a pressure screening unit, a disc filter, a flotation plant or also a sedimentation installation. In this separation apparatus 6, cellulosic particulates are extracted at 7 and subsequently as necessary undergo coagulation 8, for example by flotation. Clear filtrate drawn from the coagulation 8 and consisting substantially of water or water containing soluble chemicals is drawn off at 9.

In the separation apparatus 6 not only are cellulosic particulates of unbleached feedstock material drawn off, but in particular the unbleached feedstock material or fibrous material or the filtrate is cleansed of the unwanted cellulosic particulate from the pulp production; this is extracted from the feedstock material, which is thus cleansed thereof at 10, and may be fed for example to a bleaching step (not shown).

The suspension containing the particulates is either passed through the coagulation stage 8 and then drawn off from said coagulation stage 8 either supplied directly to the papermaking machine 4 via line 11 and used for surface finishing, or as applicable mixed at 12 with other cellulosic and/or fibrous particulates, additives and chemicals that may be contained from paper production and are supplied via line 18.

Alternatively, however, the method may also be arranged so as to bypass the coagulation stage 8, in which case the particulates drawn off at 7 undergo further treatment as described above via line 11.

The particulates recovered from the pulp, paper, cardboard or paperboard production plant can be applied to the fibrous material in the paper, cardboard or paperboard machine 4. The filtrate from the dewatering of the paper, cardboard or paperboard machine 4 is again forwarded to a separation stage 14 via line 13, at which separation 14 particulates are separated from the clear filtrate. This separation may in turn be performed by flotation or for example with disc filters. The clear filtrated recovered in this separation may in turn either be fed directly to the papermaking machine 4 via line 15 or as applicable again mixed with another clear filtrate 16, which may come from an optional coagulation stage 17, and then fed to the paper, cardboard or paperboard machine 4. The cellulosic particulates which are concentrated further in the additional coagulation stage 17 are mixed with the cellulosic particulates originating from the pulp production plant 2 at 12, and then supplied to the paper, cardboard or paperboard machine 4 via line 11.

With a method arrangement of such kind, it is possible to separate cellulosic and/or fibrous particulates contained in the filtrates and/or fibre suspensions from paper, cardboard, and/or pulp production from said filtration, to concentrate the material and apply it as a surface finishing material to a previously manufactured paper, cardboard or paperboard web, whereby it is then possible not only to significantly improve the surface properties of the paper, cardboard or paperboard, but in particular it is also possible to realise a considerable reduction of the dosage of retention agents, possibly even to dispense with them entirely, and moreover avoid the adverse effect of the particulates on dewatering in paper production.

In the following, the invention will be explained in greater detail with reference to exemplary embodiments.

### Example 1: Mechanical Paper Properties

After application of the particulates recovered from paper production (solid content ≥0.3% mass fraction particulates in water) to the moist base paper, the effect on the mechanical paper properties was investigated. It is clearly evident that the application of particulates—regardless of the application process—affects the mechanical paper properties positively. The application of particulates brings about a densification of the fibre network and leads to more fibre-particulate bonds, which have positive effects on important mechanical properties such as tensile strength, rigidity, tensile energy absorption (TEA). An increase in the mechanical paper properties can be detected in application quantities greater than about 1 g/m², wherein the improvements in the mechanical paper properties increase in line with the quantity of applied particulates.

The following examples (I) to (IV) were each carried out with a particulate application weight of 3 g abs. dry/m² on a paper sheet with a mass per unit area of 100 g/m².

In example (I), and improvement of about 10% in the mechanical paper properties was achieved with a particulate application weight of 3 g abs. dry/m² on a paper sheet with a mass per unit area of 100 g/m².
A) Tensile strength—measured in accordance with ISO 1924-3-2005
a.) Unprocessed paper—untreated sample→7.5 kN/m
b.) Paper+applied particulate→8.2 kN/m
B) Tensile Energy Absorption—measured in accordance with ISO 1924-3-2005
a.) Unprocessed paper—untreated sample→165 J/m²
b.) Paper+applied particulate→180 J/m²
C) Stiffness—measured in accordance with ISO 1924-3-2005
a.) Unprocessed paper—untreated sample→775 kN/m
b.) Paper+applied particulate→850 kN/m

Papers treated with particulates also have a high grease resistance. Depending on the type and application, a KIT value (test for grease resistance with KIT values from 1—no grease barrier to 12—excellent grease barrier) as high as 11 is possible.

In example (II), grease resistance was measured (KIT value measured based on T559-cm-2012)
Unprocessed paper—particulate-free, untreated→KIT value=1
Paper surface-treated with particulate→KIT value=11

A further advantage is that with the application of the particulates it becomes possible to obtain a closed paper surface. This was characterized using Bendtsen air permeability (unit: millilitres of air per minute).

In example (III), air permeability was measured based on Bendtsen (DIN 53120-1-2018)
Unprocessed paper—particulate-free, untreated→222 ml/min
Paper treated with particulate→0 ml/min (impermeable)

Particulates also improve the water vapour transmission (WVT, unit: water vapour mass per m² in 24 hours) of the paper and they can serve as a water vapour barrier or to improve the water vapour transmission of various paper types. A low WVT is of particular concern for packaging papers and can be influenced positively with the particulates.

In example (IV), the water vapour transmission was measured according to ISO 2528-2017.
Unprocessed paper—particulate-free, untreated→WVT=425 g/m²*24 h
Paper treated with particulate→WVT=170 g/m²*24 h

### Example 2. Enhanced Effectiveness of Additives, Economies of Retention Agents

If particulates from a separation-/coagulation step are not returned “back” to the circuit as usual, i.e. return to the machine reservoir after grinding, where among other things the additives are also introduced in doses, advantages are realised of almost 100% retention and greater effectiveness of the dosed additives, for example of cationic starch for increasing mechanical strength. The mode of action is explained in that particulates have a large specific surface and anionic charge, which means they readily bind cationic starch, with the result that the increase in tensile strength of the end product is more modest. With the process arrangement according to the invention, the fraction of particulates in the machine reservoir falls, thus affording the ability to obtain comparable paper properties even with a lower dosage of starch or another cationic synthetic or natural polymer.

Particulates were removed from an industrially ground pulp (low consistency grinding to a freeness of 20° SR), so that the freeness could be lowered to 15° SR (measured according to ISO 5267-1:1999). The air resistance also fell noticeably (from 15 seconds to less than 10 seconds). Surprisingly, the tensile strength of laboratory sheets (according to ISO 1924-3:2005, laboratory sheets according to ISO 5269-2:2004, grammage according to ISO 536:2012) only fell slightly as a result of the reduced particulate content. The pulp was diluted with the filtrate from a papermaking machine to 0.5% material density or solid content, and the pH was adjusted to pH 6.8 with aluminium sulfate. Then, dosage series with cationised starch (2 similar types) were carried out, to the effect that 10 kg starch/t pulp, and 15 kg/t and 20 kg/t were dosed. Then, laboratory sheets with 80 g/m² were produced. The laboratory sheets were acclimatised overnight at 23° C. and 50% rel. humidity, and then tested.

The results of the tests are presented in Table 1

| | | Reduced particulate | | | | | | | Reference with particulate | | | | | |
|---|---|---|---|---|---|---|---|---|---|---|---|---|---|---|
| | | Cationised starch type 2 | | | | Cationised starch type 1 | | | Cationised starch type 2 | | | Cationised starch type 1 | | |
| | Reference | 0% | 1% | 1.5% | 2% | 1% | 1.5% | 2% | 1% | 1.5% | 2% | 1% | 1.5% | 2% |
| Freeness | 20 | 15 | n.i. | n.i.. | n.i. | n.i.. | n.i. | n.i.. | n.i. | n.i.. | n.i. | n.i.. | n.i.. | k.A. |
| ° SR | | | | | | | | | | | | | | |
| Grammage | 79 | 79 | 81 | 78 | 77 | 77 | 78 | 79 | 78 | 79 | 81 | 81 | 81 | 81 |
| g/m² | | | | | | | | | | | | | | |
| Air | 15.6 | 4.92 | 3.65 | 3.39 | 3.26 | 3.18 | 3.35 | 3.40 | 10.3 | 9.18 | 8.69 | 9.47 | 9.08 | 9.64 |
| resistance | | | | | | | | | | | | | | |
| s/(l/(m²*s)) | | | | | | | | | | | | | | |
| Tensile | 84.57 | 82.70 | 98.51 | 102.59 | 105.69 | 101.77 | 105.84 | 106.56 | 101.09 | 104.33 | 103.10 | 98.33 | 100.86 | 107.475 |
| strength | | | | | | | | | | | | | | |
| N*m/g | | | | | | | | | | | | | | |
| Elongation | 2.80 | 2.78 | 3.35 | 3.39 | 3.47 | 3.46 | 3.50 | 3.51 | 3.33 | 3.36 | 3.42 | 3.33 | 3.35 | 3.53 |
| at break % | | | | | | | | | | | | | | |
| Stretching | 692.8 | 678.7 | 697.9 | 683.0 | 673.3 | 637.8 | 680.6 | 684 | 682.2 | 710.9 | 712.8 | 703.4 | 699.6 | 718.7 |
| stiffness | | | | | | | | | | | | | | |
| kN/m | | | | | | | | | | | | | | |
| Spec. tear | 12.7 | 13.4 | 11.8 | 10.1 | 9.90 | 10.2 | 9.94 | 10.5 | 9.81 | 9.12 | 9.32 | 10.0 | 9.54 | 9.32 |
| propagation | | | | | | | | | | | | | | |
| resistance | | | | | | | | | | | | | | |
| mN*m²/g | | | | | | | | | | | | | | |
| Spec. | 5.91 | 6.54 | 7.43 | 8.58 | 8.41 | 8.06 | 8.53 | 8.83 | 7.80 | 8.17 | 8.24 | 7.82 | 8.28 | 8.03 |
| rupture | | | | | | | | | | | | | | |
| angle | | | | | | | | | | | | | | |
| kPa*m²/g | | | | | | | | | | | | | | |
| Spec. | 1.66 | 1.59 | 2.19 | 2.31 | 2.41 | 2.31 | 2.44 | 2.45 | 2.24 | 2.33 | 2.34 | 2.21 | 2.27 | 2.51 |
| tensile | | | | | | | | | | | | | | |
| energy | | | | | | | | | | | | | | |
| absorption | | | | | | | | | | | | | | |
| J/g | | | | | | | | | | | | | | |
| Degree of | 18.86 | 19.54 | 19.04 | 19.16 | 18.95 | 18.93 | 19.19 | 19.06 | 16.42 | 16.50 | 16.66 | 16.86 | 16.67 | 16.69 |
| whiteness | | | | | | | | | | | | | | |
| % ISO | | | | | | | | | | | | | | |

### Example 3

After the application or spreading of the particulates (application weight >1 g abs. dry/m²) on the dry paper sheet, a reduction of the air permeability (measured with Gurley ISO 5636-3-2013-11) and the Bendtsen roughness (measured according to ISO 8791-2-2013-9) was achieved.
Pattern 1. Paper without particulates—LD according to Gurley=15 s (seconds)
   Paper treated with particulates—LD according to Gurley=126 s
Pattern 2. Paper without particulates—Roughness according to Bendtsen=1575 ml/min
   Paper treated with particulates—Roughness according to Bendtsen=673 ml/min

From the ratio between the tensile strength and Gurley air resistance, which is significantly improved by the method arrangement compared with the state of the art, it is evident that the separation of the cellulosic particulates out of the filtrates and/or fibre suspensions of a paper, cardboard, paperboard or pulp production plant and the subsequent application of same to the paper surface has the effect of enabling the realisation of a substantial improvement in the properties of the paper, paperboard or cardboard.

1. Method for separating particulates out of fibre suspensions and/or filtrates of a paper, cardboard, paperboard- or pulp production plant and for repeat application of the separated particulates to a surface of paper, cardboard or paperboard, wherein at least the following steps are carried out
a) separation of cellulosic particulates out of the filtrates with a size less than 1200 μm, (measured according to ISO 16065-1) and of further contained additives,
b) coagulating the separated cellulosic particulates,
c) mixing the separated cellulosic particulates with further particulates from paper, cardboard, paperboard or pulp production, and/or micro- or nanofibrillated cellulose (MFC or NFC),
d) forming an aqueous suspension from the cellulosic particulates, or from the mixture of particulates originating from paper, cardboard, or paperboard production with additives,
e) adding to the suspension of additives used in paper, cardboard, paperboard or pulp production selected from native, derivatized or oxidatively treated starch, sizing agents, wet strength agents or other chemical additives or from minerals selected from calcium carbonate or kaolin,
f) homogeneous application of the suspension formed to the surface of a paper, cardboard or paperboard web in a quantity between 4 and 15 g abs. dry/m² (abs. dry=absolutely dry) of the solids present in the suspension, wherein the particulate content in the suspension constitutes up to 100% of a dry mass contained in the suspension, and
g) drying the paper, cardboard or paperboard and simultaneous or subsequent pressing, sanitizing, coating with additives in a film- or pond-style size press or a spraying process or other coating units used in paper, cardboard and paperboard production,
h) repeating steps f) and g).

2. The method according to claim 1, wherein one or more of the fibre suspensions and/or the filtrates is/are introduced into a papermaking machine, cardboard or paperboard machine or pulp production plant after a pressure screening system selected from a curved screen or a belt washer, which are used in the separation step for separating particulates and other contained additives.

3. The method according to claim 1, wherein the separation of the particulates out of the fibre suspensions and/or filtrates is carried out in a single- or multistage filtration and flotation process with a disc filter or a flotation process.

4. The method according to claim 1, wherein the coagulation is performed until a total solid content comprising particulates and additives originating from paper, cardboard or paperboard production between 1 and 30% by weight is achieved.

5. The method according to claim 1, wherein at least one additive selected from the group consisting of calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents is/are added as further additives to the suspension formed from the particulates for surface treatment of paper, cardboard or paperboard.

6. The method according to claim 5, wherein a ratio of particulates to further additives between 1:100 and 100:1 is selected.

7. The method according to claim 5, wherein the particulates are used as particulates impregnated with the further additives originating from paper, cardboard or paperboard production selected from calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents, or as adducts of the further additives on the surface of the particulates.

8. The method according to claim 1, wherein a pH of the suspension to be applied to a paper, paperboard or pulp surface is chosen between pH 2 and pH 11.

9. The method according claim 1, wherein a surface coating of a paper web, cardboard or paperboard web having a dry content between 2% and 100% with a film press or pond-style size press or a spraying process is used as a surface coating process.

10. The method according to claim 1, wherein after the surface coating process a surface finishing process selected from sanitizing, pressing, drying on a polished machine smoothed Yankee cylinder, or a coating system selected from film- or pond-style size press, rolling or calendering is carried out.

11. A paper, cardboard or paperboard produced according to the method according to claim 1, wherein the paper, cardboard or paperboard has a surface coating which contains between at least 4 g abs. dry/m² and 15 g abs. dry/m² particulates and further additives.

12. A paper, cardboard or paperboard according to claim 11, wherein the surface coating includes a mixture of particulates selected from a mixture of particulates and additives originating in the filtrates from paper, cardboard, paperboard- or pulp production, selected from calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents.

13. The paper, cardboard or paperboard according to claim 11, wherein besides particulates, the mixture of particulates and the additives originating in the filtrates from paper, cardboard, paperboard- or pulp production, selected from calcium carbonate, talcum, clay, titanium dioxide, alkylated ketene dimers (AKD), alkenyl succinic acid anhydride (ASA), cationic or native/anionic resin sizes, fatty acids, cationic starch or native, enzymatically or oxidatively degraded starch and retention agents, the surface coating contains further additives selected from tensides, polyacrylic acid salts, wet strength agents or rheology additives, which are added before the coating.

14. A paper, cardboard or paperboard according to claim 11, wherein the further additives of the surface coating are contained in a quantity from 0.5% by weight to 99% by weight of the dry mass of the coating.
